(19) United States
(12) Patent Application Publication
(10) Pub. No.: US 2009/0303424 A1
(43) Pub. Date: Dec. 10, 2009

(54) LIQUID CRYSTAL DISPLAY AND METHOD FOR MANUFACTURING THE SAME

(76) Inventors: Yun-Seok LEE, Cheonan-si (KR); Cheon-Jae Maeng, Suwon-si (KR)

Correspondence Address: Frank Chau, Esq.;F. CHAU & ASSOCIATES, LLC, 130 Woodbury Road, Woodbury, NY, 11797, US

(21) Appl. No.: 12/271,462

(22) Filed: Nov. 14, 2008

(30) Foreign Application Priority Data
Jun. 5, 2008 (KR) 10-2008-0053051

(51) Int. Cl. G02F 1/1333

(52) U.S. Cl. 349/122; 349/187

(57) ABSTRACT

A liquid crystal display and a manufacturing method thereof. The liquid crystal display includes a first substrate and a second substrate, a thin film transistor formed on the first substrate, a color filter formed on the thin film transistor, an overcoat formed on the color filter and having a contact hole, a pixel electrode formed on the overcoat and connected to the thin film transistor through the contact hole, and a liquid crystal layer formed between the first substrate and the second substrate, wherein the overcoat except at the contact hole has the same planar shape as the pixel electrode. Accordingly, deterioration of the liquid crystal layer may be prevented in the liquid crystal display and a pattern of a pixel electrode may be easily formed.

### CROSS-REFERENCE TO RELATED APPLICATION

This application claims priority to and the benefit of Korean Patent Application No. 10-2008-0053051 filed in the Korean Intellectual Property Office on Jun. 5, 2008, the entire contents of which are incorporated herein by reference.

### BACKGROUND OF THE INVENTION

(a) Technical Field

The present invention relates to a liquid crystal display and a manufacturing method thereof.

(b) Discussion of the Related Art

A liquid crystal display (LCD) is one of the most commonly used flat panel displays, and it includes two substrates with field generating electrodes formed thereon and a liquid crystal layer interposed between the two substrates. In the LCD, voltages are applied to the electrodes to realign liquid crystal molecules of the liquid crystal layer so as to regulate the transmittance of light passing through the liquid crystal layer.

Among the LCDs, an LCD having a structure in which field generating electrodes are respectively formed on two display panels is known. Among such LCDs, a known LCD has a structure including a plurality of pixel electrodes and thin film transistors arranged in a matrix form on one display panel and color filters of red, green, and blue formed on the other display panel with one common electrode covering the entire surface thereof.

However, in such an LCD, the pixel electrodes and the color filters are disposed on different display panels from each other so that it is difficult to align the pixel electrodes and the color filters with each other, thereby generating an alignment error.

To address the alignment error, a color filter on array (CoA) structure in which the pixel electrodes and the color filters are formed on the same display panel was provided.

When the color filters and the pixel electrodes are formed on the same display panel, an overcoat made of an inorganic material is formed on the color filters to prevent contamination of the liquid crystal layer by the materials of the color filters.

In such a CoA structure, the overcoat made of the inorganic material is formed between the color filters and the pixel electrodes, and a portion where the liquid crystal molecules are not uniformly filled in the liquid crystal layer may exist. As a result, display deterioration may occur.

### SUMMARY OF THE INVENTION

A liquid crystal display, according to an exemplary embodiment of the present invention, includes a first substrate and a second substrate, a thin film transistor formed on the first substrate, a color filter formed on the thin film transistor, an overcoat formed on the color filter and having a contact hole, a pixel electrode formed on the overcoat and connected to the thin film transistor through the contact hole, and a liquid crystal layer formed between the first substrate and the second substrate, wherein the overcoat except at the contact hole has the same planar shape as the pixel electrode.

The overcoat may comprise an inorganic insulating material such as silicon nitride or silicon oxide.

The pixel electrode and the overcoat may include a plurality of cutouts.

Each cutout may include at least one stem and a plurality of slits formed substantially perpendicular to the stem, and a width of the slits may be smaller than a width of the stem.

The liquid crystal display may further include a passivation layer formed between the thin film transistor and the color filter.

The passivation layer may comprise an inorganic layer.

A light blocking member formed on the first substrate or the second substrate may be further included.

The overcoat may be formed by an etch process using the pixel electrode as a mask.

A manufacturing method of a liquid crystal display, according to an exemplary embodiment of the present invention, includes forming a thin film transistor, forming a color filter on the thin film transistor, depositing an insulating layer on the color filter, sequentially forming a conductive layer and a photoresist pattern on the insulating layer, etching the conductive layer using the photoresist pattern as an etch mask to form a pixel electrode, and etching the insulating layer using the pixel electrode as an etch mask to form an overcoat.

The forming of the overcoat may comprise dry etching.

The overcoat may comprise an inorganic insulating material.

Removal of the photoresist pattern after forming the overcoat may be further included.

The photoresist pattern may be removed by using wet etching.

The insulating layer and the photoresist pattern may be simultaneously etched in the forming of the overcoat.

The insulating layer and the photoresist pattern may be simultaneously dry-etched.

A liquid crystal display, according to an exemplary embodiment of the present invention, comprises a first substrate and a second substrate, a thin film transistor formed on the first substrate, a color filter formed on the thin film transistor, an overcoat formed on the color filter, a pixel electrode formed on the overcoat, wherein the pixel electrode includes a plurality of cutouts, and wherein the overcoat includes the plurality of cutouts and has substantially the same planar shape as the pixel electrode.

Each of the first and second cutouts may include at least one stem and a plurality of slits formed substantially perpendicular to the stem. A distance between each of adjacent slits may be substantially uniform.

### BRIEF DESCRIPTION OF THE DRAWINGS

FIG. 1 is a layout view of a liquid crystal display according to an exemplary embodiment of the present invention.

FIG. 2 is a layout view of a thin film transistor array panel in the liquid crystal display shown in FIG. 1.

FIG. 3 is a cross-sectional view of the liquid crystal display shown in FIG. 1 taken along the lines III-III′ and III′-III″.

FIG. 4 to FIG. 11 are cross-sectional views, taken along the lines IV-IV′ and IV′-IV″ shown in FIG. 2, showing steps of a manufacturing method of the thin film transistor array panel shown in FIG. 2, according to an exemplary embodiment of the present invention.

FIG. 12 is a cross-sectional view, taken along the lines IV-IV′ and IV′-IV″ shown in FIG. 2, showing a step of a manufacturing method of the thin film transistor array panel shown in FIG. 2, according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or intervening elements may also be present.

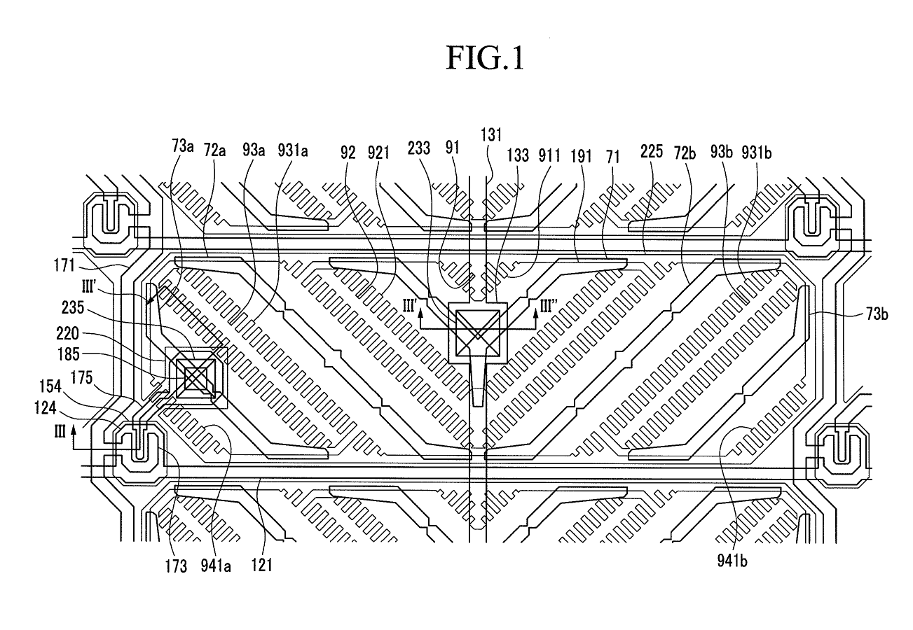

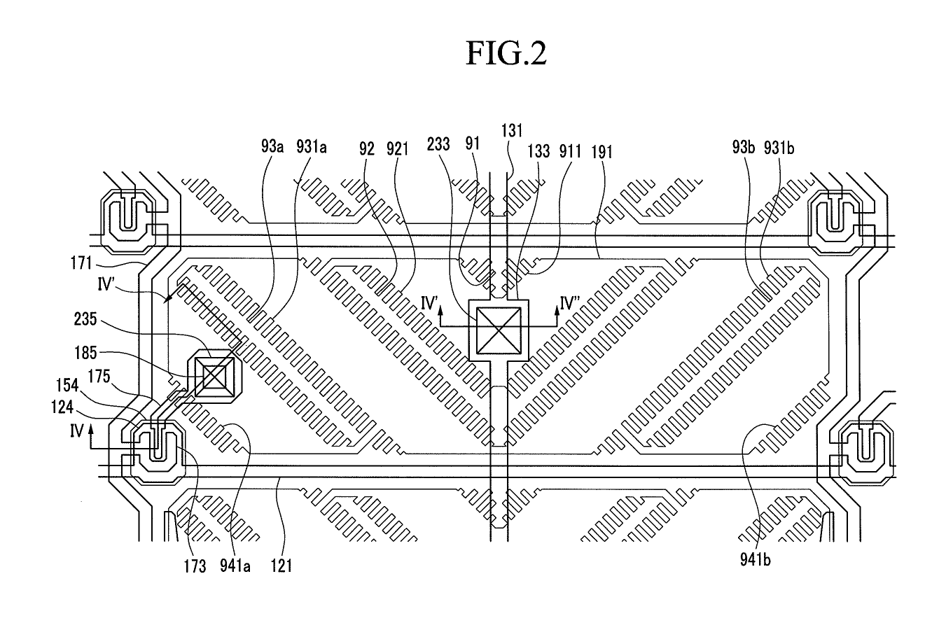

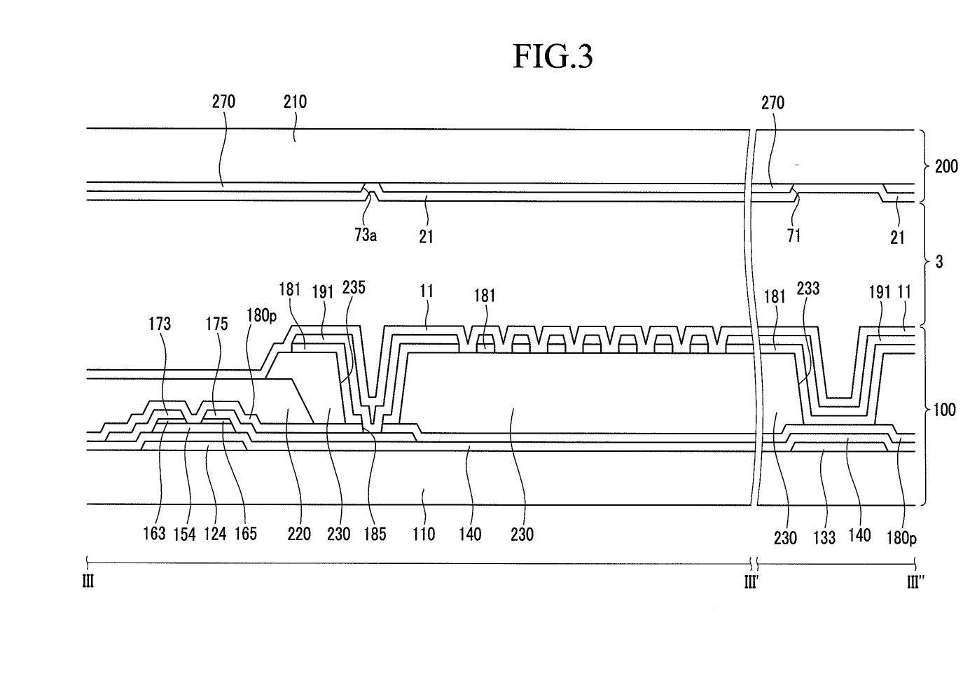

FIG. 1 is a layout view of a liquid crystal display according to an exemplary embodiment of the present invention, FIG. 2 is a layout view of a thin film transistor array panel in the liquid crystal display shown in FIG. 1, and FIG. 3 is a cross-sectional view of the liquid crystal display shown in FIG. 1 taken along the lines III-III′ and III′-III″.

Referring to FIG. 1 to FIG. 3, a liquid crystal display according to an exemplary embodiment of the present invention includes a thin film transistor array panel 100 and a common electrode panel 200 facing each other, and a liquid crystal layer 3 disposed therebetween.

The thin film transistor array panel 100 includes a plurality of gate lines 121 and a plurality of storage electrode lines 131 formed on an insulating substrate 110. The insulating substrate 110 may be made of a material such as transparent glass or plastic.

The gate lines 121 transmit gate signals and extend in a transverse direction. Each of the gate lines 121 includes a plurality of gate electrodes 124 protruding therefrom, for example, in an upward direction.

The storage electrode lines 131 receive a predetermined voltage such as a common voltage and are substantially perpendicular to the gate lines 121. Each storage electrode line 131 is disposed between adjacent gate electrodes 124 and may be disposed at the same distance from the adjacent gate electrodes 124. For example, the storage electrode line may be disposed to be equidistant between two adjacent gate electrodes. Each storage electrode line 131 includes a plurality of storage electrodes 133 having a quadrangular shape. However, the shape and the arrangement of the storage electrode lines 131 may be variously changed.

A gate insulating layer 140 made of, for example, a silicon nitride (SiNx) or silicon dioxide (SiOx) is formed on the gate lines 121 and the storage electrode lines 131.

A plurality of semiconductor islands 154 made of, for example, hydrogenated amorphous silicon (simply referred to as a-Si) or crystallized silicon are formed on the gate insulating layer 140. The semiconductor islands 154 are respectively disposed on the gate electrodes 124.

A pair of ohmic contact islands 163 and 165 are formed on each semiconductor island 154. The ohmic contacts 163 and 165 may be made of n+ hydrogenated a-Si heavily doped with an N-type impurity such as phosphorous, or the ohmic contacts 13 and 165 may be made of silicide.

A plurality of data lines 171 and a plurality of drain electrodes 175 are formed on the ohmic contacts 163 and 165 and the gate insulating layer 140.

The data lines 171 transmit data voltages and extend in a longitudinal direction, thereby intersecting the gate lines 121. Each data line 171 includes a plurality of curved portions curving, for example, two times, to partially surround the gate electrode 124 and the semiconductor island 154. Each data line 171 also includes a plurality of source electrodes 173 extending in a “U” shape from the curved portions toward the gate electrodes 124. The source electrodes 173 are positioned opposite the drain electrodes 175 with respect to the gate electrodes 124.

The drain electrode 175 starts from one end portion enclosed by the source electrode 173, extends upward, curves obliquely, for example, to the right, and terminates at the other end portion thereof with a wide area.

A gate electrode 124, a source electrode 173, and a drain electrode 175 form a thin film transistor (TFT) along with a semiconductor island 154. The channel of the thin film transistor is formed in the semiconductor island 154 between the source electrode 173 and the drain electrode 175.

The ohmic contacts 163 and 165 are interposed only between the underlying semiconductor islands 154 and the overlying data lines 171 and the drain electrodes 175 thereon, and reduce contact resistance therebetween. The semiconductor islands 154 include exposed portions that are not covered by the source electrodes 173 and the drain electrodes 175, such as in the channel regions between the data lines 171 and the drain electrodes 175.

A passivation layer 180p is formed on the data lines 171, the drain electrodes 175, and the exposed semiconductor islands 154. The passivation layer 180p may be made of an inorganic insulator such as silicon nitride or silicon oxide, and protects the exposed semiconductor islands 154.

A light blocking member 220, a so-called black matrix, is formed on the passivation layer 180p. The light blocking member 220 prevents light leakage, includes a plurality of openings 225, and it may further include a quadrangular portion corresponding to the area where the thin film transistors and the wide portions of the drain electrodes 175 are located.

Alternatively, the light blocking member 220 may be disposed on the common electrode panel 200.

A plurality of color filters 230 are formed on the passivation layer 180p and the light blocking member 220. The color filters 230 are mostly disposed in the space enclosed by the light blocking member 230. The color filters 230 have a plurality of through holes 235 disposed on the drain electrodes 175 and a plurality of openings 233 having a quadrangular shape disposed over the storage electrodes 133. The openings 233 decrease the thickness of the dielectric material of a storage capacitor, described further below, thereby increasing the storage capacitance.

The passivation layer 180p may prevent the pigments of the color filters 230 from flowing into the exposed semiconductor islands 154.

An overcoat 181, made of, for example, an inorganic insulator such as silicon nitride or silicon oxide, is formed on the light blocking member 220 and the color filters 230. The overcoat 181 prevents lifting of the color filters 230, and suppresses contamination of the liquid crystal layer 3 by an organic material such as a solvent flowing from the color filters 230. As a result, deterioration, such as afterimages generated as driving is performed, may be prevented. The overcoat 181 includes a plurality of cutouts having a plurality of minute slits. Further description of the overcoat 181 is provided further below.

At least one of the light blocking member 220 and the color filters 230 may be disposed in the common electrode panel 200, and one of the passivation layer 180p and the overcoat 181 of the thin film transistor array panel 100 may be omitted.

The passivation layer 180p and the overcoat 181 have a plurality of contact holes 185 exposing the drain electrodes 175. The contact holes 185 are smaller than the through holes 235 of the color filters 230 and pass through the through holes 235.

A plurality of pixel electrodes 191 are formed on the overcoat 181. The pixel electrodes 191 may be made of, for example, a transparent conductive material such as indium tin oxide (ITO) or indium zinc oxide (IZO), or a reflective metal such as aluminum, silver, chromium, or an alloy thereof.

Each of the pixel electrodes 191 has four main edges substantially parallel to the gate lines 121 and the data lines 171, of which the two transverse main edges are longer than the two longitudinal main edges. Each of the pixel electrodes 191 also has a quadrangular shape with four chamfered corners. The chamfered oblique edges of the pixel electrodes 191 form an angle of about 45 degrees with respect to the gate lines 121, and the two lower chamfered oblique edges include a plurality of minute slits 941a and 941b extending substantially perpendicular to the chamfered oblique edges.

The pixel electrodes 191 have an upper cutout 91, a center cutout 92, a left cutout 93a, and a right cutout 93b. The pixel electrodes 191 are divided into a plurality of regions by the cutouts 91-93b. The cutouts 91-93b are in inversion symmetry with respect to an imaginary longitudinal central line bisecting the pixel electrode 191.

The upper cutout 91 is disposed on the center of the upper edge of the pixel electrode 191 and has a plurality of minute slits 911 forming an angle of about 45 degrees with respect to the gate lines 121.

The center cutout 92 includes a stem with a “V” shape that starts near the upper edge of the pixel electrode 191 and extends to the lower edge of the pixel electrode 191, and a plurality of minute slits 921 formed substantially perpendicular to the stem. The stem forms an angle of about 45 degrees with respect to the gate lines 121 and includes a pair of oblique portions disposed on both sides with respect to the imaginary longitudinal central line, and the two oblique portions may be substantially perpendicular to each other.

The left cutout 93a and the right cutout 93b are respectively disposed on the left and right sides with respect to the imaginary longitudinal central line. The left cutout 93a and the right cutout 93b respectively include one stem forming an angle of about 45 degrees with respect to the gate line 121 and a plurality of minute slits 931a and 931b substantially perpendicular to the stem. The stems of the left and the right cutouts 93a and 93b extend substantially parallel to the oblique portions of the center cutout 92.

The distances between the minute slits 911, 921, 931a, and 931b formed at the cutouts 91-93b, and between the minute slits 941a, and 941b formed at the chamfered oblique edges of the pixel electrode 191 are substantially uniform, and the width of the minute slits 911-941b may be more than about 1 μm.

The overcoat 181 disposed under the pixel electrodes 191, except at the contact holes 185, has substantially the same planar shape as the pixel electrodes 191, and the above description with respect to the shape of the pixel electrodes 191 and the cutouts 91-93b also applies to the overcoat 181.

Accordingly, the overcoat 181, made of an inorganic insulating material, is not formed on the whole surface, but is only formed under the pixel electrodes 191 so that the stress in the overcoat 181 is decreased, thereby reducing influence of an external impact. Also, gases released from the color filters 230 under the overcoat 181 or an air layer formed under the overcoat 181 during a manufacturing process may easily escape before filling the liquid crystal layer 3 with liquid crystal molecules. As a result, air bubbles causing the formation of a space in the liquid crystal layer 3 not filled with the liquid crystal molecules may be prevented.

Also, the overcoat 181 remains under the pixel electrodes 191 so that transmittance of the liquid crystal display may be improved as compared with the case in which the overcoat 181 is completely removed.

The pixel electrodes 191 are connected to the drain electrodes 175 of the thin film transistors through the contact holes 185, and are supplied with data voltages from the drain electrodes 175.

The common electrode panel 200 includes a common electrode 270 formed on an insulating substrate 210. The insulating substrate may be made of a material such as transparent glass or plastic. The common electrode 270 is made of, for example, a transparent conductor such as ITO and IZO, and includes a plurality of sets of cutouts 71, 72a, 72b, 73a, and 73b.

A set of the cutouts 71-73b faces a pixel electrode 191 and includes a center cutout 71, a first left cutout 72a, a first right cutout 72b, a second left cutout 73a, and a second right cutout 73b. Each of the cutouts 71-73b is disposed between the neighboring cutouts 91-93b of the pixel electrode 191 or between the cutouts 91-93b and the lower chamfered oblique edges of the pixel electrode 191. Also, each of the cutouts 71-73b includes at least one oblique portion parallel to the stems of the center cutout 92, the left cutout 93a, or the right cutout 93b, and each oblique portion has at least one concave or convex notch. The cutouts 71-73b substantially have inversion symmetry with respect to the imaginary longitudinal central line of the pixel electrode 191.

The center cutout 71 includes a pair of oblique portions forming a “V” shape and a pair of terminal transverse portions. The terminal transverse portions extend while overlapping the upper edge of the pixel electrode 191 from the ends of the respective oblique portions, and form obtuse angles with the oblique portions.

Each of the first left cutout 72a and the first right cutout 72b includes one oblique portion and a pair of terminal transverse portions. Each of the terminal transverse portions extends while overlapping the upper or lower edge of the pixel electrode 191 from both ends of the oblique portion, and forms an obtuse angle with the oblique portion.

Each of the second left cutout 73a and the second right cutout 73b includes one oblique portion, one terminal transverse portion, and one terminal longitudinal portion. The terminal transverse portion extends while overlapping the lower edge of the pixel electrode 191 from the lower end of the oblique portion, and forms an obtuse angle with the oblique portion, and the terminal longitudinal portion extends while overlapping the left edge or the right edge of the pixel electrode 191 from the upper end of the oblique portion and forms an obtuse angle with the oblique portion.

Alignment layers 11 and 21 are coated on the inner surface of the display panels 100 and 200, respectively, and may be vertical alignment layers.

Polarizers (not shown) may be provided on the outer surfaces of the display panels 100 and 200.

The liquid crystal layer 3 has negative dielectric anisotropy. The liquid crystal molecules of the liquid crystal layer 3 may be aligned such that the major axes of the liquid crystal molecules are perpendicular to the surfaces of the two panels 100 and 200 in the absence of an electric field.

When a common voltage is applied to the common electrode 270 and data voltages are applied to the pixel electrodes 191, an electric field substantially perpendicular to the surfaces of the panels 100 and 200 is generated. The liquid crystal molecules change their orientations in response to the electric field such that their major axes become perpendicular to the electric field.

The cutouts 71-73b and 91-93b of the field generating electrodes 191 and 270 and the edges of the pixel electrodes 191 distort the electric field to generate a horizontal component, which determines the tilt directions of the liquid crystal molecules. The horizontal component of the electric field is substantially perpendicular to the edges of the cutouts 71-73b and 91-93b and the edges of the pixel electrodes 191. The azimuthal distribution of the tilt directions is localized to four directions. In this way, the tilt directions of the liquid crystal molecules 31 may be various, thereby increasing the reference viewing angle of the liquid crystal display.

On the other hand, the minute slits 911, 921, 931a, 931b, 941a, and 941b of the cutouts 91-93b and the lower chamfered edges of pixel electrodes 191 form grooves in the surface of the alignment layer 11 and enhance the alignment force to tilt the liquid crystal molecules perpendicular with respect to the cutouts 71-73b and 91-93b under the application of an electric field.

At least one of the cutouts 71-73b and 91-93b may be replaced with protrusions (not shown) or depressions (not shown).

The shape and the arrangement of the cutouts 71-73b and 91-93b may be variously changed according to various design elements.

The pixel electrodes 191 and the common electrode 270 form liquid crystal capacitors along with the liquid crystal layer 3 to maintain an applied voltage after the thin film transistors are turned off. Also, the pixel electrodes 191 overlap the storage electrodes 133 in the openings 233 of the color filters 230 to form storage capacitors. The storage capacitors enhance the voltage maintenance capacity of the liquid crystal capacitors.

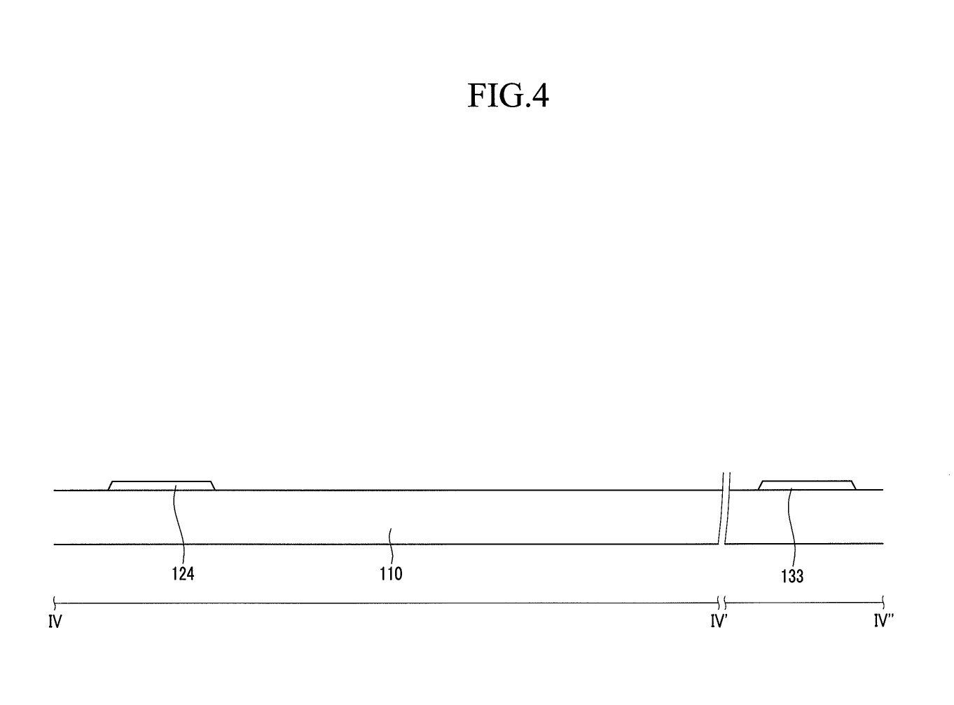

Next, a manufacturing method of a liquid crystal display will be described with reference to FIG. 4 to FIG. 12.

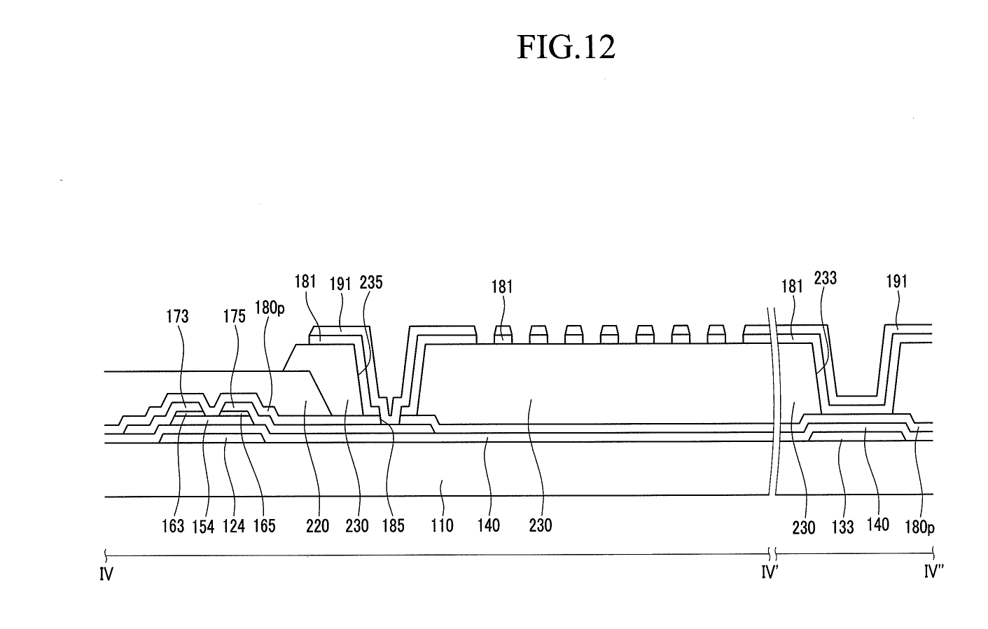

FIG. 4 to FIG. 11 are cross-sectional views taken along the lines IV-IV′ and IV′-IV″ shown in FIG. 2, showing steps of a manufacturing method of the thin film transistor array panel shown in FIG. 2 according to an exemplary embodiment of the present invention. FIG. 12 is a cross-sectional view taken along the lines IV-IV′ and IV′-IV″ shown in FIG. 2, showing a step of a manufacturing method of the thin film transistor array panel shown in FIG. 2 according to an exemplary embodiment of the present invention.

First, referring to FIG. 4, a gate conductive layer (not shown) made of a material such as aluminum or molybdenum is deposited on an insulating substrate 110 and patterned by photolithography to form a plurality of gate lines 121 including gate electrodes 124, and a plurality of storage electrode lines 131 including storage electrodes 133.

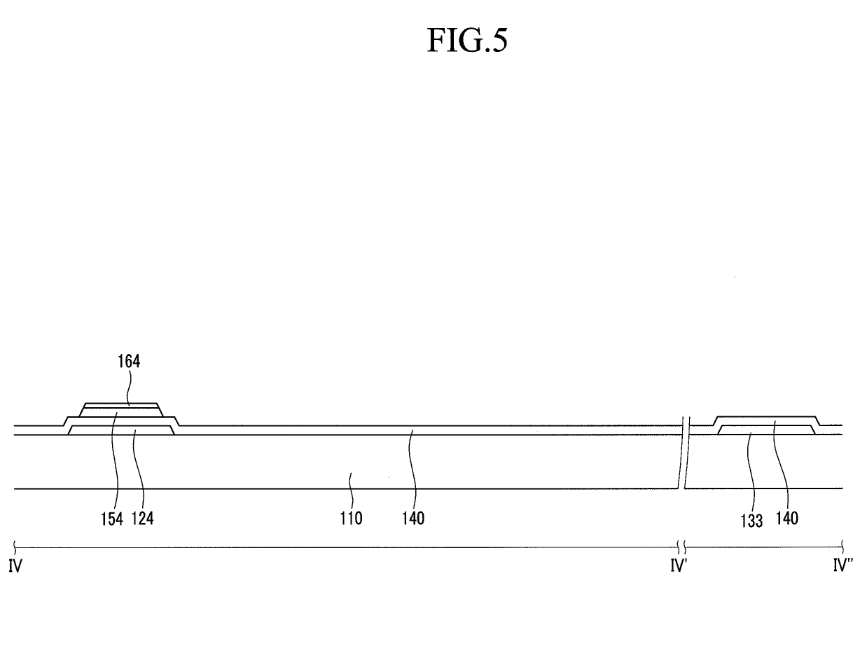

Then, as shown in FIG. 5, a gate insulating layer 140 is formed on the gate lines 121, the storage electrode lines 131, and the insulating substrate 110. Next, a semiconductor layer (not shown) and an impurity-doped semiconductor layer (not shown) are sequentially deposited and patterned by photolithography to form a plurality of semiconductor islands 154 and an ohmic contact layer 164.

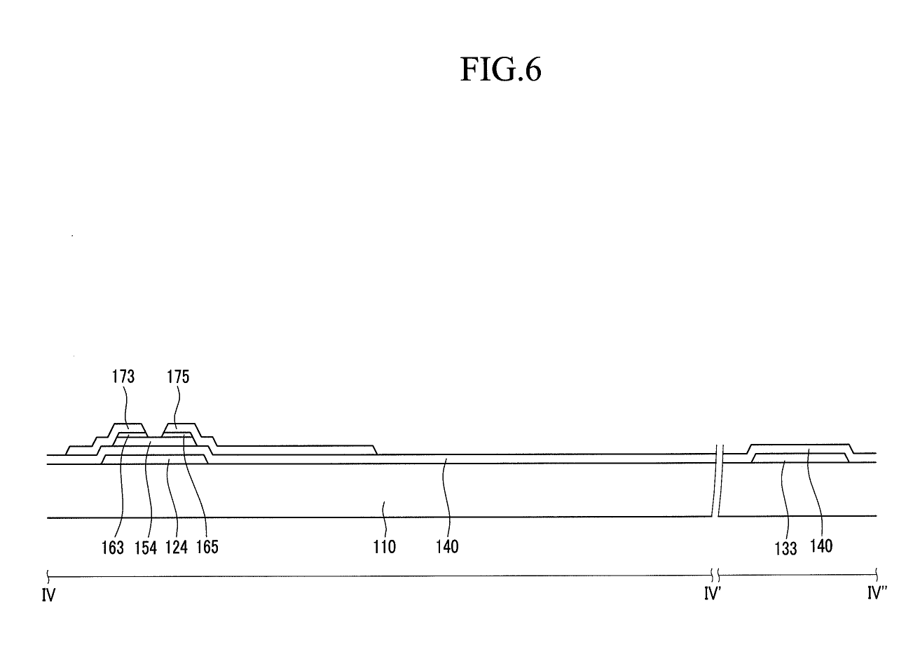

As shown in FIG. 6, a data conductive layer (not shown) is then deposited on the gate insulating layer 140 and the ohmic contact layer 164 and patterned by photolithography to form a plurality of data lines 171 including source electrodes 173 and a plurality of drain electrodes 175.

The ohmic contact layer 164 is then etched using the data lines 171 and the drain electrodes 175 as an etch mask to form a pair of ohmic contact islands 163 and 165 and to expose a portion of the semiconductor islands 154.

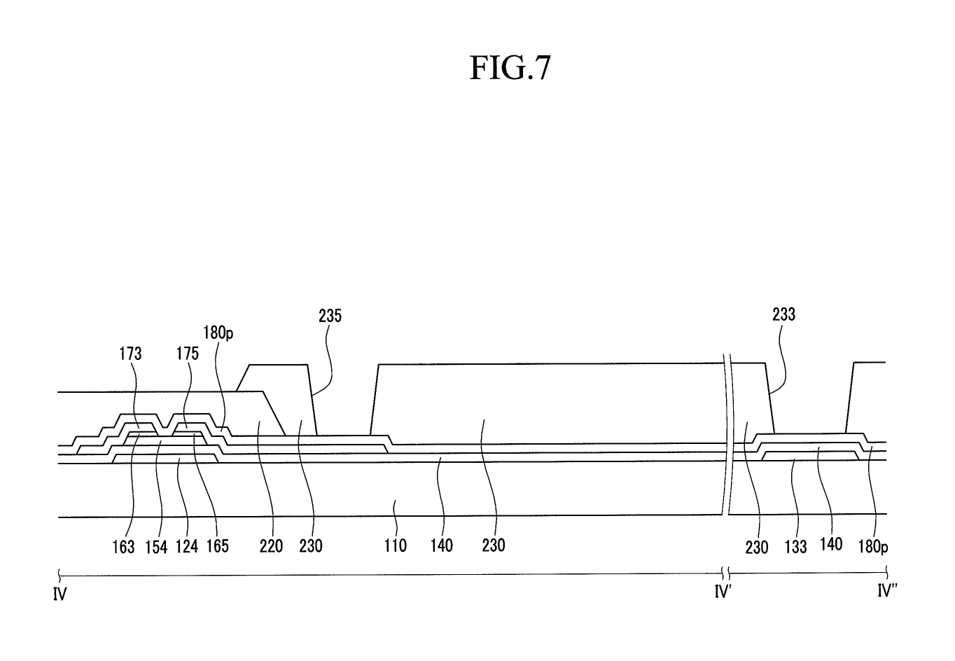

Next, as shown in FIG. 7, a passivation layer 180p is formed on the whole surface of the data lines 171, the drain electrodes 175, and the gate insulating layer 140. The passivation layer 180p may be formed of silicon nitride or silicon oxide by chemical vapor deposition (CVD).

Next, a light blocking member 220 is formed on the passivation layer 180p, and color filters 230 are formed on the light blocking member 220 and the passivation layer 180p. The color filters 230 may be formed by a solution process such as spin coating or inkjet printing, or by a deposition process using a shadow mask. In the color filters 230, through holes 235 are formed on a portion corresponding to the drain electrodes 175, and openings 233 are formed on a portion corresponding to the storage electrodes 133.

Alternatively, the light blocking member 220 may be formed in the common electrode panel 200 or on the color filters 230.

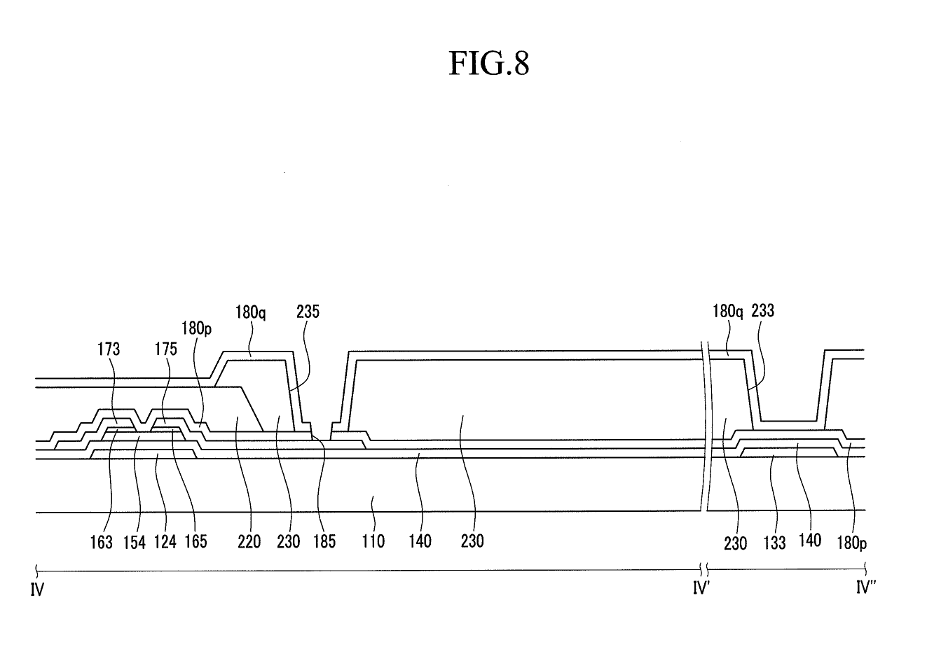

Next, as shown in FIG. 8, an overcoat layer 180q is formed on the color filters 230 and the light blocking layer 220. The overcoat layer 180q is formed of silicon nitride or silicon oxide by chemical vapor deposition.

Next, the overcoat layer 180q and the passivation layer 180p are etched together to form contact holes 185 exposing the drain electrodes 175 and disposed in the through holes 235.

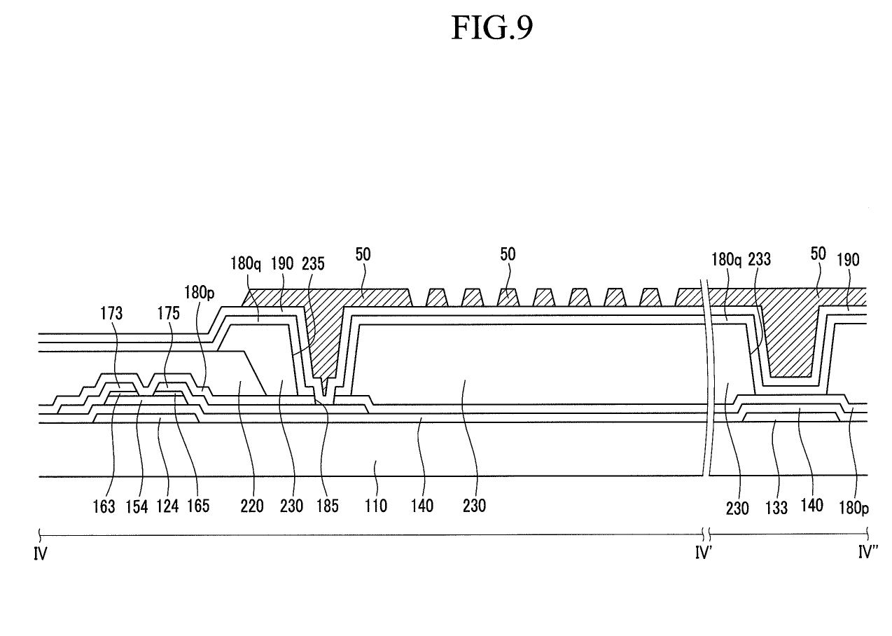

Next, as shown in FIG. 9, a conductive layer 190 for the pixel electrodes is deposited on the whole surface of the overcoat layer 180q.

Next, a photosensitive film is coated on the conductive layer 190 and is patterned to form a photoresist pattern 50.

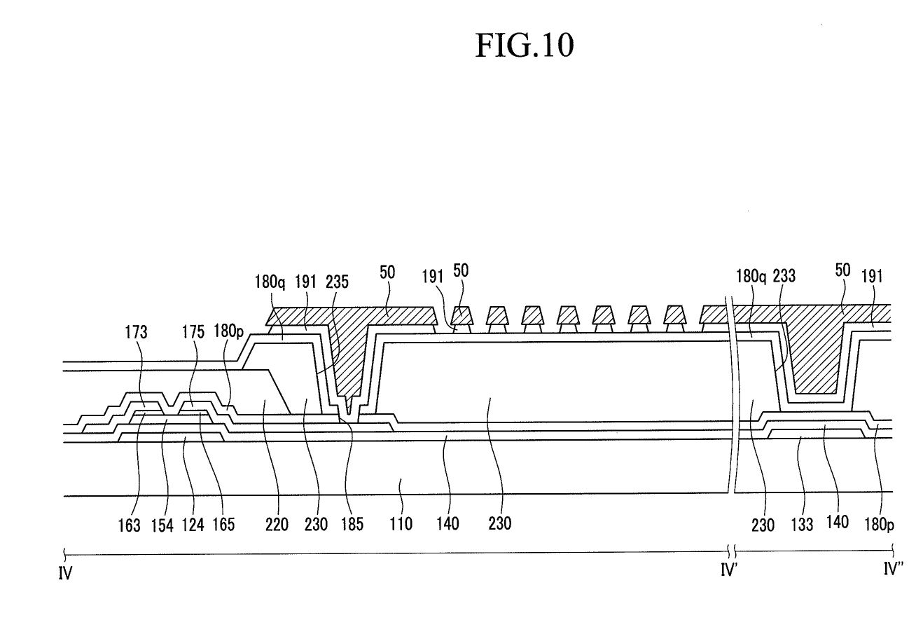

Next, as shown in FIG. 10, the conductive layer 190 is etched using the photoresist pattern 50 to form a plurality of pixel electrodes 191 including a plurality of minute slits 911-941b and cutouts 91-93b.

As a result, the pixel electrodes 191 are not formed directly on the color filters 230, which generally have bad tolerance to the etchant. Instead, the pixel electrodes 191 are formed on an overcoat layer 180q having relatively good adherence with the pixel electrodes 191. The overcoat layer is formed on the color filters 230 so that skew during a manufacturing process may be reduced and consequently minute slits 911-941b having a desired width may be formed while protecting the color filters 230.

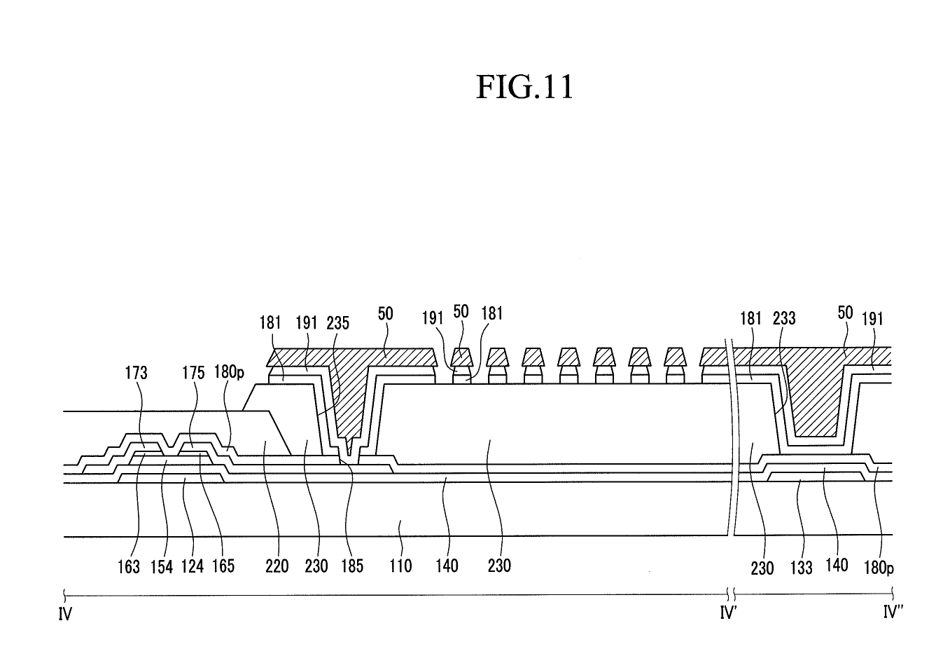

Next, as shown in FIG. 11, the exposed overcoat layer 180q that is not covered by the pixel electrodes 191 is dry-etched using the photoresist pattern 50 and the pixel electrodes 191 as an etch mask to form an overcoat 181 including minute slits and cutouts the same as those of the pixel electrodes 191. SF₆ may be used as a gas for the dry etching.

Next, as shown in FIG. 3, the photoresist pattern 50 is removed by using a stripper. Alternatively, as shown in FIG. 12, the photoresist pattern 50 on the overcoat layer 180q may be simultaneously dry-etched to be removed as the overcoat layer 180q is dry-etched to form the overcoat 181. In this case, a gas for etching the photoresist pattern 50, such as oxygen gas O₂, for example, may be included in the gas for etching the overcoat layer 180q.

As a result, the overcoat layer 180q and the photoresist pattern 50 may be etched together to form the overcoat 181 and simultaneously remove the photoresist pattern 50 so that a process for removing the photoresist pattern 50 using a stripper may be omitted. As a result, swelling of the color filters 230 and unevenness of the surface of the display panel 100 due to the stripper may be prevented. Additionally, deterioration of adhesion with another thin film that is deposited on the color filters 230 and lifting of the thin film may be prevented.

According to an exemplary embodiment of the present invention, an overcoat 181 that may be made of an inorganic insulator is formed under the pixel electrodes 191 so that it may be possible to form a pattern such as the minute slits 911-941b of the pixel electrodes 191. The overcoat 181 only exists under the pixel electrodes 191 so that the stress in the overcoat 181 may be decreased, and non-uniform filling of the liquid crystal molecules in the liquid crystal layer 3 or the generation of air bubbles may be prevented to thereby prevent deterioration of the display characteristics.

While this invention has been described in connection with exemplary embodiments, it is to be understood that the invention is not limited to the disclosed embodiments, but is intended to cover various modifications and equivalent arrangements included within the spirit and scope of the appended claims.

What is claimed is:

1. A liquid crystal display comprising:
a first substrate and a second substrate;
a thin film transistor formed on the first substrate;
a color filter formed on the thin film transistor;
an overcoat formed on the color filter and having a contact hole;
a pixel electrode formed on the overcoat and connected to the thin film transistor through the contact hole; and
a liquid crystal layer formed between the first substrate and the second substrate,
wherein the overcoat except at the contact hole has the same planar shape as the pixel electrode.

2. The liquid crystal display of claim 1, wherein
the overcoat comprises silicon nitride or silicon oxide.

3. The liquid crystal display of claim 1, wherein
the pixel electrode and the overcoat include a plurality of cutouts.

4. The liquid crystal display of claim 3, wherein
a cutout includes at least one stem and a plurality of slits formed substantially perpendicular to the stem, and a width of the slits is smaller than a width of the stem.

5. The liquid crystal display of claim 1, further comprising
a passivation layer formed between the thin film transistor and the color filter.

6. The liquid crystal display of claim 5, wherein
the passivation layer comprises an inorganic layer.

7. The liquid crystal display of claim 1, further comprising
a light blocking member formed on the first substrate or the second substrate.

8. The liquid crystal display of claim 1, wherein
the overcoat is formed by an etch process using the pixel electrode as a mask.

9. A method for manufacturing a liquid crystal display comprising:
forming a thin film transistor;
forming a color filter on the thin film transistor;
depositing an insulating layer on the color filter;
sequentially forming a conductive layer and a photoresist pattern on the insulating layer;
etching the conductive layer using the photoresist pattern as an etch mask to form a pixel electrode; and
etching the insulating layer using the pixel electrode as an etch mask to form an overcoat.

10. The method of claim 9, wherein
the forming of the overcoat comprises dry etching.

11. The method of claim 9, wherein
the overcoat comprises an inorganic insulating material.

12. The method of claim 9, further comprising
removing the photoresist pattern after forming the overcoat.

13. The method of claim 12, wherein
the photoresist pattern is removed by wet etching.

14. The method of claim 9, wherein
the insulating layer and the photoresist pattern are simultaneously etched in the forming of the overcoat.

15. The method of claim 14, wherein
the insulating layer and the photoresist pattern are simultaneously dry-etched.

16. A liquid crystal display comprising:
a first substrate and a second substrate;
a thin film transistor formed on the first substrate;
a color filter formed on the thin film transistor;
an overcoat formed on the color filter;
a pixel electrode formed on the overcoat,
wherein the pixel electrode includes a first cutout, and
wherein the overcoat includes a second cutout having substantially the same planar shape as the first cutout of the pixel electrode.

17. The liquid crystal display of claim 16, wherein each of the first and second cutouts includes at least one stem and a plurality of slits formed substantially perpendicular to the stem.

18. The liquid crystal display of claim 17, wherein a distance between each of adjacent slits is substantially uniform.
